(19) United States
(12) Patent Application Publication
(10) Pub. No.: US 2008/0238668 A1
(43) Pub. Date: Oct. 2, 2008

(54) SYSTEM AND METHOD FOR SECURITY MONITORING BETWEEN TRUSTED NEIGHBORS

(75) Inventor: Roger T. Johnsen, Salt Lake City, UT (US)

Correspondence Address: THORPE NORTH & WESTERN, LLP., P.O. Box 1219, SANDY, UT, 84091-1219, US

(73) Assignee: CONTROL4 CORPORATION, Draper, UT (US)

(21) Appl. No.: 12/057,661

(22) Filed: Mar. 28, 2008

Related U.S. Application Data
(60) Provisional application No. 60/908,607, filed on Mar. 28, 2007.

(51) Int. Cl. G08B 13/00; G08B 21/00

(52) U.S. Cl. 340/541; 340/540

(57) ABSTRACT

A system and method for security monitoring by a trusted neighbor is disclosed. In one embodiment, the system allows a security monitor in a first building to communicate with a building automation network in a second building to enable monitoring of a security sensor in the second building.

### CROSS-REFERENCE TO RELATED APPLICATIONS AND CLAIM OF PRIORITY

Priority of U.S. Provisional patent application Ser. No. 60/908,607 filed on Mar. 28, 2007 is claimed.

### BACKGROUND

Security systems and home automation networks have been popular for many years. Security systems can automatically detect conditions such as fire, water leakage, intrusions, and other conditions. Reporting these conditions to the building owner (e.g., homeowner or landlord) or other personnel can allow the owner to take action to help avoid losses to property.

While it is relatively easy to place various types of security sensors in a building, communicating alarms to the appropriate personnel is a bigger challenge. Typically, a building owner will contract with a private security firm for monitoring services. These contracts can be expensive and of limited value. For example, monthly charges on monitoring contracts can quickly exceed the initial installation cost of the security sensors.

Even when a monitoring service is used, response time can be slow and ineffective. Law enforcement agencies generally handle reports from home security systems as low priority due to false alarms. Physical response by private security personnel can take a long time, depending on the travel distances involved. As a consequence, many home and building security systems fall into disuse or fail to communicate problems to the appropriate personnel.

### SUMMARY

In one embodiment of the invention, building automation networks can be installed in a first building and a second building. The first building's automation network can include at least one first security-monitoring component, and the second building's automation network can include at least one security sensor. The security-monitoring component(s) in the first building can be used to monitor the security sensor(s) in the second building.

In another embodiment of the invention, security network components installed in a first and second building can communicate via a wireless mesh network so that status of the second building can be monitored from the first building (and/or vice versa).

In yet another embodiment of the invention, a security-monitoring component is in wireless communication with a first building's automation network to allow monitoring of the automation network, wherein the security-monitoring component can be alternatively positioned and repositioned between the first building and a second building.

Another embodiment of the invention includes a method of monitoring a building security network by a trusted neighbor. The method can include providing building automation networks in a first and second building. The first building network includes a plurality of security sensors and the second building network includes at least one security monitor. The method can also include monitoring the status of at least one of the security sensors in the first building using the security monitor in the second building.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a block diagram of a system for security monitoring between trusted neighbors in accordance with an embodiment of the present invention;

FIG. 2 is a block diagram of a system for security monitoring between trusted neighbors with several alternate communications paths in accordance with an embodiment of the present invention;

FIG. 3 is a block diagram of an alternate arrangement of a system for security monitoring between trusted neighbors using a wireless mesh network in accordance with an embodiment of the present invention;

FIG. 4 is a block diagram of a system for security monitoring between trusted neighbors having a relocatable monitoring console in accordance with an embodiment of the present invention; and

FIG. 5 is a flow diagram of a method of monitoring a building security network by a trusted neighbor.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

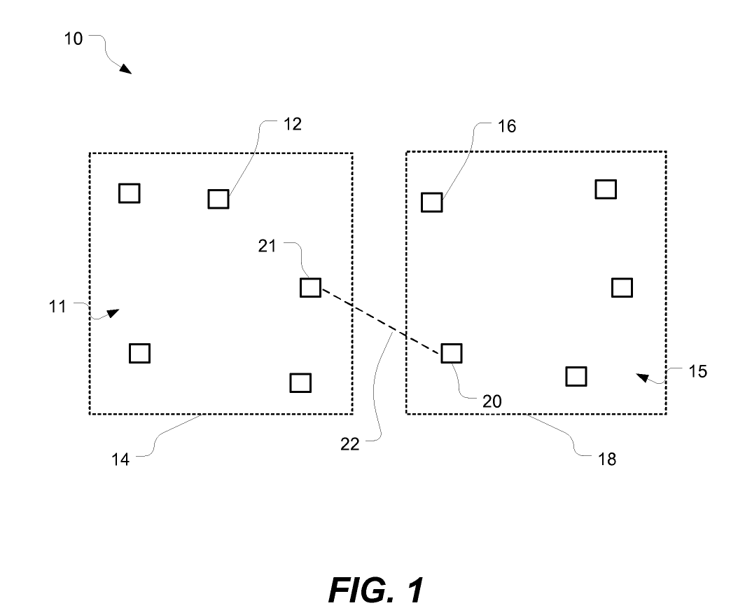

As illustrated in FIG. 1, a system 10 for security monitoring between trusted neighbors is illustrated in block diagram form in accordance with an embodiment of the invention. The system includes a first building automation network 11 installed in a first building 14, and a second building automation network 15 installed in a second building 18. The first building automation network includes a plurality of first building automation networking components, for example, component 12. The building automation network components can include security sensors, security monitors, lighting controllers, audio/visual components, climate control, and the like. The second building automation network includes a plurality of second building automation networking components, for example, component 16. Communications are provided between the first building automation network and the second building automation network, for example using wireless communication, a wireless mesh network, or other networks as will be described further below.

A trusted neighbor can use the first building automation network 111 to monitor the second building automation network 15. The trusted neighbor can be selected by the first building's owner, and may be a nearby building owner or other person. One of the first building automation networking components 16 can include a first building security-monitoring component 21. The first building security-monitoring component can include a display, such as a visual display, LCD screen, indicator lights, audible alarm, and the like. One of the second building automation networking components includes a second building security sensor 20. The security sensor can include a motion detector, a broken glass sensor, an intrusion sensor, a sound sensor, a microphone, a camera, a door opening sensor, a window opening sensor, a pressure sensor, an infrared sensor, a heat sensor, a fire sensor, a chemical sensor, a gas sensor, a moisture sensor, a vibration sensor, a contact sensor, a wind sensor, and the like. The first building security-monitoring component is in networked communication 22 with the second building security sensor to enable monitoring of the second building security sensor by the first building automation network. The first building security-monitoring component can also be in communication with the first building automation networking components to enable monitoring of the first building automation network.

This system can provide an alternative to using a private security firm to monitor the system. Neighbors can monitor each other's homes through such systems. This allows a security alarm in a first house to be communicated to a display in a second house. Several advantages are made possible by this arrangement. Since the neighbors may be in close proximity, response time to an alarm can be reduced. Personal friendships can also help to provide a greater sense of responsibility and urgency in responding to an alarm. When a reciprocal monitoring arrangement is provided, neighbors have a greater motivation to help each other out. Unlike some prior art alarm systems which are noisy and tend to disturb many neighbors, alarms in this system can be directed to a single neighbor.

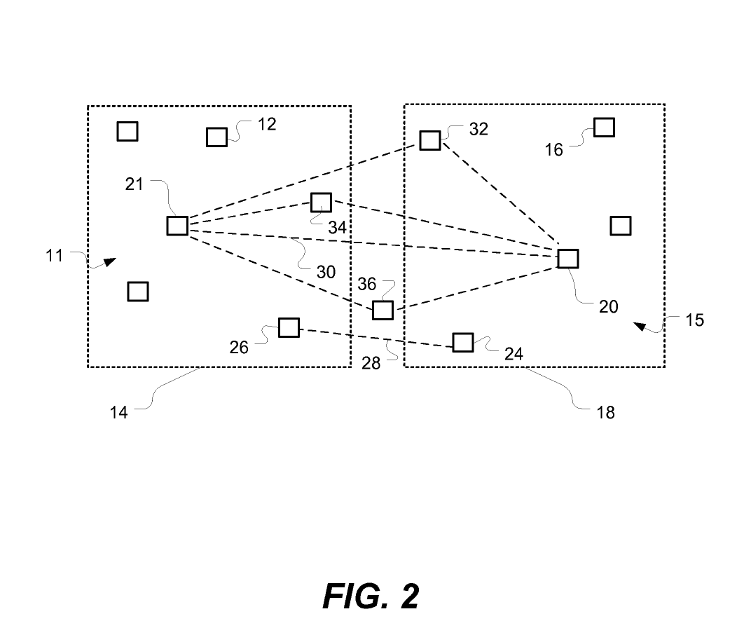

The system 10 can provide reciprocal monitoring ability as illustrated in FIG. 2. The second building automation networking components can include a second building security-monitoring component 24 and the first building automation networking components can include a first building security sensor 26. The second building security-monitoring component can communicate 28 with the first building security sensor to enable monitoring of the first building security sensor by the second building automation network 15.

Turning to the network communications of the system in further detail, various ways of providing communication between the building automation networks can be used, as illustrated in FIG. 2. For example, communication between the security-monitoring component 21 and security sensor 20 can be via wireless communication 30, either direct or indirect. As another example, one or more components within the first or second building automation network can provide a communication relay 32, 34 between the monitoring component and security sensor. Various wireless communications protocols are known which can be adapted to the system, including, for example, the ZigBee™ protocol and the IEEE 802 wireless communication protocols.

In one embodiment, communication between the first building automation network 11 and the second building automation network 15 can be provided via a network bridge or wireless repeater 36, allowing relay between the first building security-monitoring component 21 and the second building security sensor 20. A network bridge or wireless repeater can allow the distance between the first building and second building to be greater than a normal communication range of the building automation network components. Hence, it is not necessary that the neighbors be immediately adjacent. For example, a network bridge can be implemented using virtual local area network (VLAN) techniques. A network bridge can also help to allow communications between network components using different communications protocols, such as equipment manufactured by different companies. For example, higher layer communications protocols may be implemented to provide communications between networks which have elements using different lower layer communications protocols to communicate within their networks.

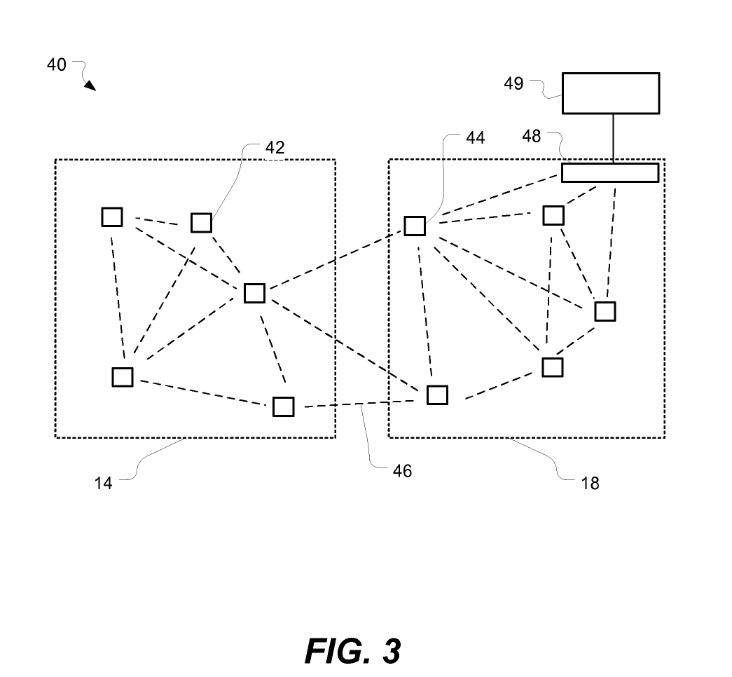

As another example, communications can be provided via a mesh network. For example, FIG. 3 illustrates an alternate arrangement of a system 40 in accordance with an embodiment of the present invention. A plurality of first building security network components 42 are installed in a first building 14, and a plurality of second building security network components 44 are installed in a second building 18. The first and second building security network components are in communication in a wireless mesh network 46. For example, as mentioned above, the ZigBee™ protocols can provide for a wireless mesh network that includes relay functions. Neighboring networks may be operated on the same ZigBee channel to provide direction communications. As another example, neighboring networks may be operated on different ZigBee™ channels, and a communication relay can provide a bridge between the networks. Various other suitable communications protocols suitable for use in the present invention will occur to one of ordinary skill in the art. The communications protocols can be an open standard (such as ZigBee™ protocols, Bluetooth®) protocols, and the like) or a proprietary technique.

The wireless mesh network 46 enables communication between the first building security network components 42 and the second building security network components 44. For example, a first building security network component can display a status of the second building security network components. Similarly, a second building network component can display status of the first building security network components. This can be in addition to building security network components displaying status of the own corresponding security networks.

The wireless network need not be a fully connected mesh. For example, network components can include a relay or routing function to allow relay of communications between network components that are not in direct wireless communication. The system can also include a relay node configured to relay wireless communications between the first building security network and the second building security network. The system can also include a gateway 48 (e.g., a ZigBee™ gateway) to connect to other external communication networks 49, such as the telephone system, internet protocol (IP) networks, or the like.

Status display can be provided by a monitor component, such as a display panel. In one embodiment, a display panel can provide alarm indications, display of environmental conditions (e.g., temperature, humidity, smoke detected, etc.), viewing of camera images, and the like. The display panel may also provide control features (e.g., building automation controls and enabling/disabling the security network).

It will be appreciated that neighbors may not wish to allow each other complete access to each other's building security system. Accordingly, the system can include access controls to moderate information flow between the first building and the second building. For example, a monitoring component can include a user interface having an input device to allow setting of user-defined access limits for information flow between the first building and the second building. Access limits may include limiting information flow from particular components (e.g., a camera) and groups (or classes) of components (e.g., intrusion sensors and camera).

For example, consider the situation where the first building is a business. The security system may include intrusion alarms and one or more cameras. The intrusion alarms may be disabled during normal business hours, but the camera(s) may provide images to a recorder. During normal business hours, transmissions of images from the camera(s) may be limited to within the first building's network. After normal business hours, images from the camera(s) may be allowed to be communicated to a display in the second building to allow visual verification by the neighbor when an intrusion alarm is generated.

As another example, consider where the first building is a home. It may be desirable to communicate information from security sensors such as fire alarms and the like to the second building at all times. In contrast, communication of images from cameras and the like may only be provided to the second building when the first building occupant is away from home. For example, when first building occupant leaves the home, they may enable intrusion alarms and communication of camera images to the second building. Hence, a control panel or user interface in the first building may provide for alternatively enabling or disabling access between the monitoring component in the second building and one or more sensors in the first building. In general, a system user can define access limits that control how information flows within the network. Limits can be set on what kind of information is allowed to flow between different network elements and which network elements are allowed to communicate with each other.

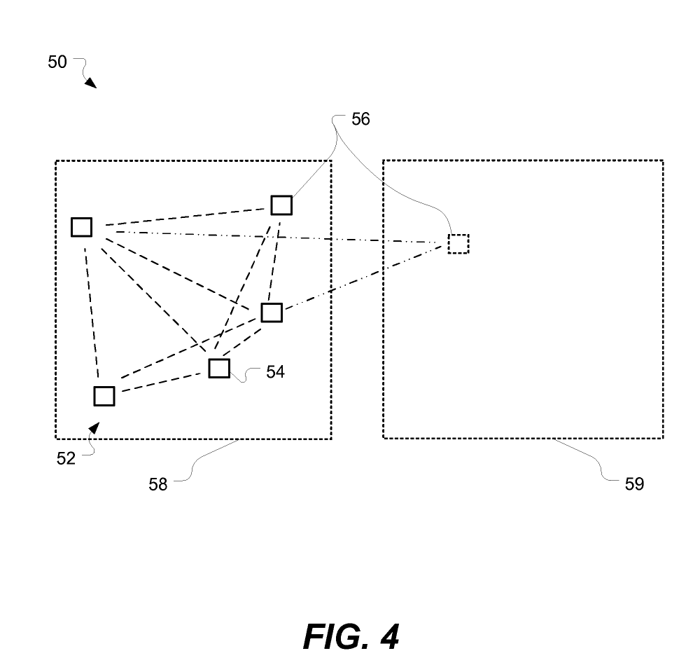

FIG. 4 illustrates another embodiment of a system 50 for security monitoring between trusted neighbors. The system includes a building automation network 52 installed in a first building 58. The building automation network includes at least one security sensor 54 installed in the first building. A security-monitoring component 56 is in wireless communication with the building automation network. For example, the security-monitoring component can be alternatively positioned and repositioned between the first building and a second building 59.

An example application of the system 50 will be illustrated using home security systems as an example. The security-monitoring component 56 may be a relocatable monitoring console for a first homeowner's home security system (building automation network 52). Normally, the monitoring console may reside in the first home (building) 58, allowing the first homeowner to control the home security system. When desired, for example if the first homeowner is going on vacation, the monitoring console can be carried to a neighbor's home (building) 59, allowing the neighbor to monitor the home security system. Note that the system 50 does not require the neighbor to have a home security system of his/her own.

The system 50 can include multiple monitoring consoles 56. For example, there may be a monitoring console permanently installed in the first building 58 and one or more monitoring consoles which can be easily moved to desired locations.

A monitoring console may also provide for control of the home security system. As discussed above, user-defined access limits may limit information flow from the building automation network 52 to a monitoring console. For example, some monitoring consoles may have access to information from all of the security sensors, and other monitoring consoles may receive only limited information or have access to only certain security sensors. For example, as described above, smoke or fire detection alarms might be communicated to all monitoring consoles, and camera images communicated to only certain monitoring consoles.

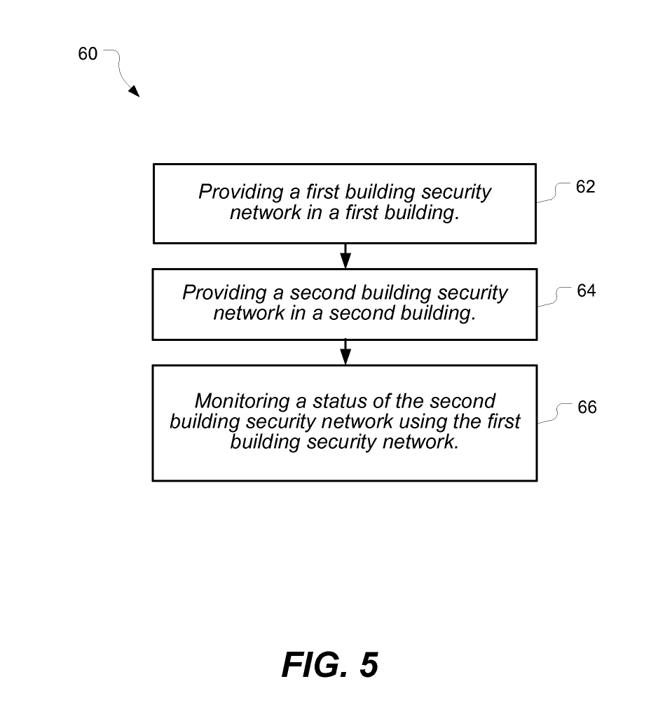

In accordance with another embodiment of the present invention, a method of monitoring a building security network by a trusted neighbor will now be described. The method 60 is illustrated in flow chart form in FIG. 5, in accordance with an embodiment of the present invention. The method includes a step of providing 62 a first building automation network in a first building, the first building automation network having a plurality of security sensors. The method also includes a step of providing 64 a second building automation network in a second building, the second building automation network having at least one security monitor. The method also includes monitoring 66 a status of at least one of the plurality of security sensors in the first building using the security monitor in the second building. Several different ways of providing building automation networks and monitoring are described above.

In accordance with another embodiment of the present invention, the method can also include monitoring a status of at least one security sensor that is in the second building using a security monitor in the first building. Accordingly, reciprocal monitoring between neighboring buildings can be provided.

In accordance with another embodiment of the present invention, the method can also include limiting information flow from the second building security network to the first building security network. For example, as discussed above, user-defined access limits can be input through a user interface.

In summary, some benefits of embodiments of the present invention include the ability to allow a trusted neighbor to provide security monitoring. A first homeowner can loan a portable monitoring console to a neighboring homeowner to allow monitoring of the first homeowner's security system by the neighbor, for example, while the first homeowner is on vacation. Neighbors, each having a home automation network, can enable communication between their networks to allow monitoring of security sensor information originating from their neighbor's house. Access controls can be included in the system to limit what information flows between the neighbor's networks. Communications between neighbors' networks can be implemented wirelessly (including direct communication links, mesh networks, relay nodes, and the like) and can include bridges (including gateways and VLANs) and wireless repeaters.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A system for security monitoring between trusted neighbors, comprising
a first building automation network having a plurality of first building automation networking components installed in a first building, wherein at least one of the plurality of first building automation networking components includes a first building security-monitoring component;
a second building automation network having a plurality of second building automation networking components installed in a second building, wherein at least one of the plurality of second building automation networking components includes a second building security sensor; and
wherein the first building security-monitoring component is in communication with the second building security sensor to enable monitoring of the second building security sensor by the first building automation network.

2. The system of claim 1, wherein:
the plurality of second building automation networking components includes a second building security-monitoring component; and
the plurality of first building automation networking components includes a first building security sensor; and
wherein the second building security-monitoring component is in communication with the first building security sensor to enable monitoring of the first building security sensor by the second building automation network.

3. The system of claim 1, wherein the first building security-monitoring component is in direct wireless communication with the second building security sensor.

4. The system of claim 1, wherein at least one of the plurality of second building automatic networking components provides a communication relay between the first building security-monitoring component and the second building security sensor.

5. The system of claim 1, wherein at least one of the plurality of first building automation networking components provides a communication relay between the first building security-monitoring component and the second building security sensor.

6. The system of claim 1, further comprising a network bridge providing communication relay between the first building security-monitoring component and the second building security sensor.

7. The system of claim 1, further comprising a radio frequency repeater to relay wireless communications between the first building security-monitoring component and the second building security sensor.

8. The system of claim 1, wherein the at least one first building security sensor is chosen from the group of sensors consisting of a motion detector, a broken glass sensor, an intrusion sensor, a sound sensor, a microphone, a camera, a door opening sensor, a window opening sensor, a pressure sensor, an infrared sensor, a heat sensor, a fire sensor, a chemical sensor, a gas sensor, a moisture sensor, a vibration sensor, a contact sensor, and a wind sensor.

9. The system of claim 1, wherein the communication between the first building security-monitoring component and the second building security sensor is moderated by the second building automation network.

10. The system of claim 1 wherein the first building security-monitoring component comprises a user interface having a display and an input device.

11. A system for security monitoring between trusted neighbors, comprising:
a plurality of first building security network components installed in a first building;
a plurality of second building security network components installed in a second building;
wherein the plurality of first building security network components and the plurality of second building security network components are in communication in a wireless mesh network, so that at least one of the first building security network components displays status of at least one of the second building security network components, and at least one of the second building security network components displays status of at least one of the first building security network components.

12. The system of claim 11, wherein information flow between the first building security network components and the second building security network components is limited by at least one user-defined access limit.

13. The system of claim 11, wherein the building security network components comprise a security sensor chosen from the group of sensors consisting of a motion detector, a broken glass sensor, an intrusion sensor, a sound sensor, a microphone, a camera, a door opening sensor, a window opening sensor, a pressure sensor, an infrared sensor, a heat sensor, a fire sensor, a chemical sensor, a gas sensor, a moisture sensor, a vibration sensor, a contact sensor, and a wind sensor.

14. The system of claim 11, further comprising a relay node configured to relay wireless communications between the first building security network and the second building security network.

15. The system of claim 11, wherein the wireless mesh network is fully connected.

16. A system for security monitoring between trusted neighbors, comprising:
a building automation network having at least one security sensor installed in a first building;
a security-monitoring component in wireless communication with the building automation network to allow monitoring of the at least one security network component, wherein the security-monitoring component can be alternatively positioned and repositioned between the first building and a second location.

17. The system of claim 16, wherein the security-monitoring component is further configured to provide control of the building automation network.

18. The system of claim 16, wherein information flow from the at least one security sensor to the monitoring component is limited based on user-defined access limits.

19. The system of claim 16, wherein the building automation network comprises a plurality of security network components interconnected in a wireless mesh network.

20. A method of monitoring a building security network by a trusted neighbor, comprising the steps of:
providing a first building automation network in a first building, the first building automation network having a plurality of security sensors;
providing a second building automation network in a second building, the second building automation network having at least one security monitor; and
monitoring a status of at least one of the plurality of security sensors in the first building using the security monitor in the second building.

21. The method of claim 20, wherein:
the second building automation network has a plurality of security sensors;
the first building automation network has at least one security monitor; and
further comprising the step of monitoring a status of at least one of the security sensors in the second building using the security monitor in the first building.

22. The method of claim 20, further comprising limiting information flow from the second building security network to the first building security network based on user-defined access limits.

23. The method of claim 22, wherein the user-defined access limits comprise alternatively enabling or disabling access between the first building security network and a particular component of the second building security network.
